(19) United States
(12) Patent Application Publication
(10) Pub. No.: US 2011/0228070 A1
(43) Pub. Date: Sep. 22, 2011

(54) System and Method for Determining Image Focus by Sampling the Image at Multiple Focal Planes Simultaneously

(76) Inventors: Courosh Mehanian, Redmond, WA (US); Yuval Ben-Dov, Cambridge, MA (US); Andrew V. Hill, San Jose, CA (US)

(21) Appl. No.: 12/941,054

(22) Filed: Nov. 6, 2010

Related U.S. Application Data
(60) Provisional application No. 61/259,170, filed on Nov. 7, 2009.

(51) Int. Cl. H04N 7/18; H04N 5/232

(52) U.S. Cl. 348/79; 348/345; 348/E05.045; 348/E07.085

(57) ABSTRACT

A system and method for maintaining focus in an imaging device; the imaging device having an objective lens with an optical axis, a stage for supporting a specimen, and a controller for controlling the stage-to-objective distance; the system comprising: one or more image sensors placed at a plurality of substantially different axial focal positions, and at least one computing device executing computer-readable instructions stored in its memory and configured to acquire images from each of the image sensors; the method comprising: computing a quantitative image characteristic for each of the images acquired by the computing device, computing an axial stage-to-objective distance correction based on the computed quantitative image characteristics and the plurality of axial focal positions, and causing the controller to adjust the axial stage-to-objective distance according to the computed axial stage-to-objective distance correction.

### CROSS-REFERENCE TO RELATED APPLICATIONS

This application claims priority to U.S. provisional patent application No. 61/259,170, filed on Nov. 7, 2009, entitled, “System For Determining Image Focus By Sampling The Image At Multiple Focal Planes Simultaneously”, which is incorporated herein by reference as if set forth in its entirety.

### BACKGROUND OF THE DISCLOSURE

Scanning microscopes are employed for recording digital images of biological specimens which are subsequently reviewed by histologists, pathologists, or computer-aided analysis systems. Poor image quality can hinder a person's or computer's ability to interpret image content. Specimen-to-objective distance can change as a result of variations in specimen thickness and coverslip thickness, and because of stage jitter and lack of stage flatness. The sum of these variations in specimen distance can exceed the depth of field of a high-magnification objective. A scanning microscope equipped with an autofocus system should keep the specimen in focus while not compromising scan speed.

### BRIEF SUMMARY OF THE DISCLOSURE

The present disclosure teaches an autofocus system of a scanning microscope wherein images are acquired at multiple focal positions substantially simultaneously. This enables the computation of focus scores at multiple positions on the focus curve substantially simultaneously. From this plurality of focus scores a section of the focus curve that brackets the focal position of the primary sensor is computed. From this computed focus curve, it is determined whether the primary image sensor is in focus (substantially at the peak of the focus curve). More generally, both the magnitude and sign of the correction needed to bring the primary image sensor into focus is computed. In this manner, the autofocus system continuously computes focus correction values that are used to maintain the primary image sensor in focus. The scanning proceeds continuously, while specimen-to-objective distance is adjusted continuously according to the focus correction computed at a slightly earlier scan position.

A number of different embodiments are described herein. In some embodiments there are multiple image sensors at multiple focal positions. In other embodiments, the multiple focal positions are sampled using at least one tilted image sensor. In the embodiments with multiple image sensors, we sometime refer to a primary image sensor and at least one autofocus image sensor. The autofocus image sensors may be used as the primary image sensor and the decision may be made dynamically. The primary image sensor may be used as an autofocus image sensor and the decision may be made dynamically.

### BRIEF DESCRIPTION OF THE SEVERAL VIEWS OF THE DRAWING

Like labels refer to like parts throughout the drawings.

FIG. 1 shows an embodiment of a light microscope with an infinity-corrected optical system.

FIG. 2A shows one embodiment of the present disclosure with three image sensors at three different focal positions.

FIG. 2B shows one embodiment for the fields of view of the image sensors within the field of view of the objective lens of the embodiment of FIG. 2A. In this embodiment, the three image sensors are linescan or TDI linescan sensors.

FIG. 2C shows a different embodiment for the fields of view of the image sensors within the field of view of the objective lens of the embodiment of FIG. 2A. In this embodiment, all three image sensors are 2D area sensors.

FIG. 3 shows a focus curve computed from the focus scores computed from images acquired by three sensors at three different focal positions in FIG. 2A.

FIG. 4 shows a flowchart for the method of the present disclosure that pertains to the embodiment of FIG. 2A.

FIG. 5A shows one embodiment with three image sensors in three different optical paths at three different focal positions. The autofocus optical paths are generated using beamsplitters.

FIG. 5B shows one embodiment for the fields of view of the image sensors within the field of view of the objective lens of the embodiment of FIG. 5A. In this embodiment, all three sensors are linescan or TDI linescan sensors with substantially identical fields of view.

FIG. 5C shows a different embodiment for the fields of view of the image sensors within the field of view of the objective lens of the embodiment of FIG. 5A. In this embodiment, all three sensors are 2D area sensors with substantially identical fields of view.

FIG. 6A shows one embodiment of the present disclosure with a single image sensor. The image sensor is tilted with respect to the optical axis such that many focal positions are imaged simultaneously.

FIG. 6B shows one embodiment for the field of view of the image sensor within the field of view of the objective lens of the embodiment of FIG. 6A. In this embodiment, the image sensor can be a 2D area sensor or a TDI linescan sensor. The image from the image sensor is segmented into 9 focal position zones.

FIG. 7 shows a focus curve computed from focus scores computed from the image acquired by the tilted image sensor at multiple focal positions in FIG. 6A.

FIG. 8A shows an embodiment of the present disclosure with three image sensors. The primary image sensor is at a fixed focal position. The two autofocus image sensors are tilted with respect to the optical axis such that many focal positions are imaged simultaneously. The autofocus image sensors are placed in alternative optical paths generated by beamsplitters.

FIG. 8B shows one embodiment for the fields of view of the image sensors within the field of view of the objective lens of the embodiment of FIG. 8A. In this embodiment, the primary image sensor is a linescan or TDI linescan sensor, and the two autofocus image sensors are 2D area sensors, each segmented into 9 zones corresponding to 9 focal positions. The fields of view of the two autofocus image sensors have substantially identical fields of view.

### DETAILED DESCRIPTION OF THE DISCLOSURE

In the following description, numerous specific details are set forth in order to provide a thorough understanding of various embodiments. However, it will be understood by those skilled in the art that the various embodiments may be practiced without the specific details. In other instances, well-known methods, procedures, components, and circuits have not been described in detail so as not to obscure the particular embodiments.

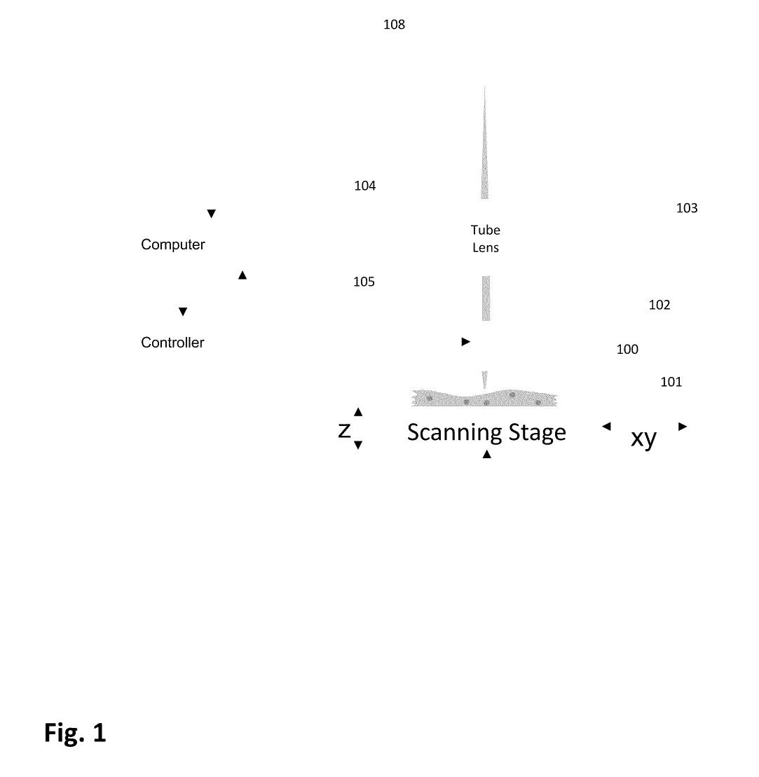

FIG. 1 shows one embodiment of a light microscope with an infinity-corrected optical system. When this microscope scans a specimen at high magnification, the depth of field of the objective lens is insufficient to keep the specimen in focus because of variations in specimen thickness, variations in coverslip thickness, tilt of the moving stage, and jitter of the moving stage. The present disclosure will describe an autofocus system and method that keeps the specimen in focus while scanning.

In many microscopes, image focus is adjusted by adjusting the stage-to-objective distance in a direction parallel to the optical axis. Because of the optical principle of conjugate planes, there is a one-to-one correspondence between positions along the optical axis on the object side and positions along the optical axis on the image side. Thus, multiple focal planes may be sampled by placing image sensors at multiple positions on the image side. We use the term focal position to refer to both the position of image sensors on the image side and stage-to-objective positions on the object side.

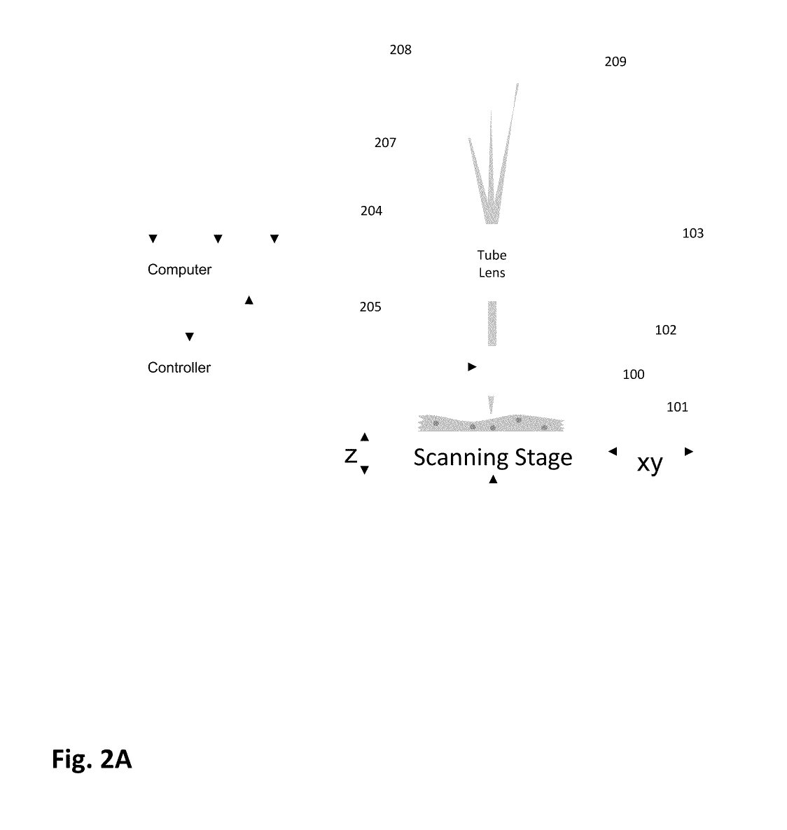

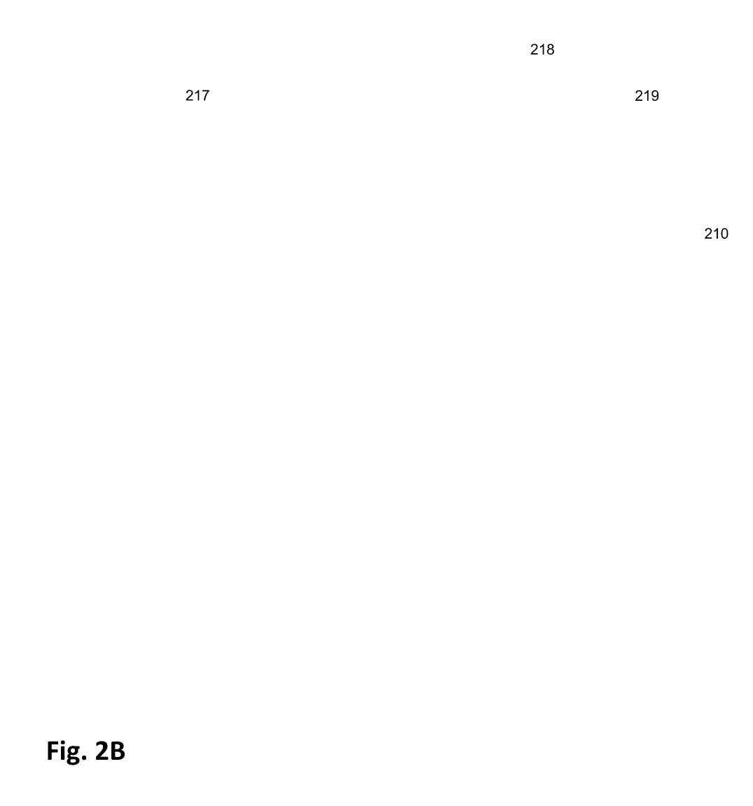

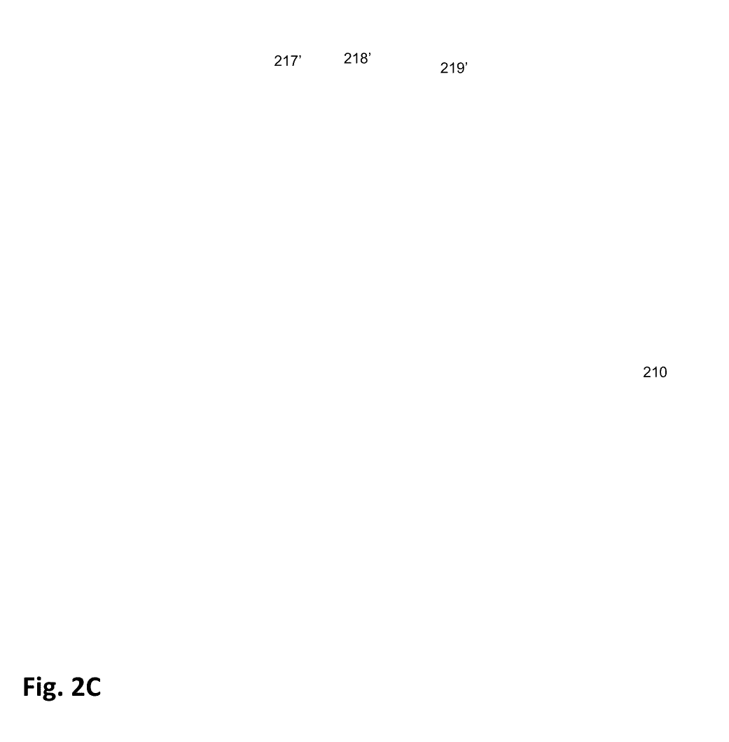

FIG. 2A shows one embodiment of the present disclosure, with three image sensors 207, 208, and 209 placed at three different focal positions. Other embodiments have a different number of image sensors. The computing device 204 has at least one processing unit that executes computer-readable instructions stored in the memory of the computing device for performing the methods of the present disclosure. The computing device 204 acquires the images from the image sensors 207, 208, and 209. In the embodiment shown in FIG. 2A, focus is adjusted by adjusting the stage-to-objective distance along the optical axis of the microscope. The stage movement is directed by the controller 205 by executing stage-movement instructions that are provided to it by the computer 204 using the methods of the present disclosure.

FIG. 2B shows one embodiment for the non-overlapping fields of view of the three image sensors within the field of view of the objective lens. The fields of view 217, 218, and 219 shown in FIG. 2B correspond to image sensors that are linescan or TDI linescan sensors. FIG. 2C shows a different embodiment for the non-overlapping fields of view of the three image sensors within the field of view of the objective lens. These fields of view 217′, 218′, and 219′ correspond to image sensors that are 2D area sensors.

In one embodiment, the fields of view of the three image sensors do not overlap, but as the specimen moves under the microscope objective by action of the stage 101, the three image sensors will acquire images of the same region of the specimen at successive times. When all three image sensors have acquired an image of the same specimen region, quantitative focus scores can be computed for all three focal positions. Various embodiments use different focus score computation algorithms, depending on the application and the imaging modality.

The focus score algorithm for various embodiments emphasize particular characteristics of the specimen being analyzed. For example, red blood cells in tissue have a tendency to float to the bottom surface of the coverslip, providing an unreliable feature on which to base specimen focus. In one embodiment, the focus score computation algorithm suppresses red objects when computing the focus score. Various embodiments emphasize image features based on their color. Various other embodiments de-emphasize image features based on their color. Various other embodiments do one of emphasize and de-emphasize image features based on at least one characteristic selected from the group color, transmittance, reflectance, polarization retardance, size, shape, and texture.

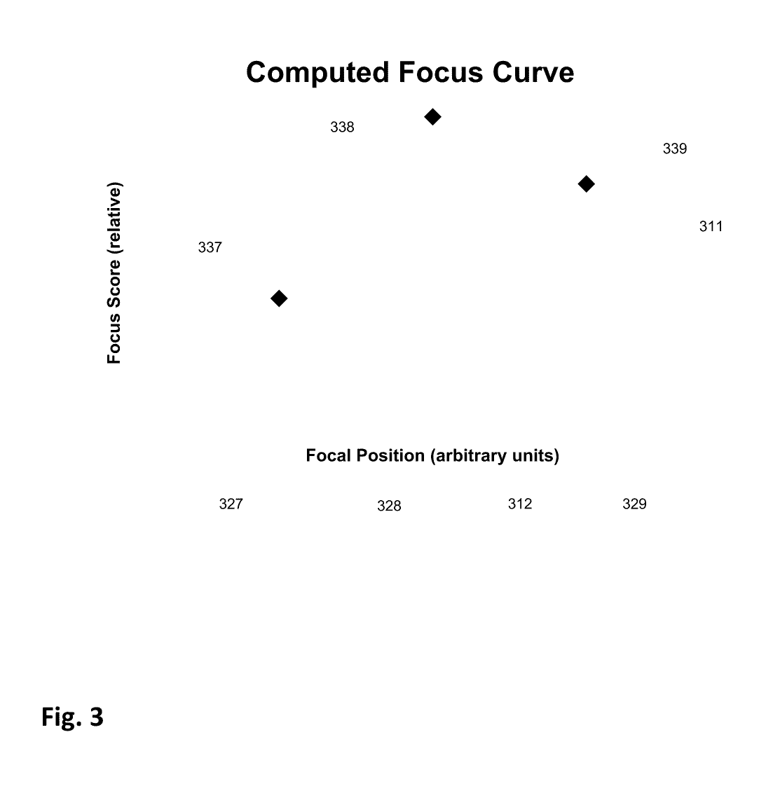

In FIG. 2A, the three image sensors 207, 208, and 209 are placed at three different focal positions. Referring to FIG. 3, these focal positions are marked as 327, 328, and 329 on the abscissa of the graph. From the three computed focus scores 337, 338, and 339, focus curve 311 is computed, using at least one of curve fitting and interpolation algorithms. In the example shown in FIG. 3, the primary image sensor is at focal position 328, which is not at the peak of the computed focus curve 311. Thus the primary image is not in focus. The computed focus curve has a peak at focal position 312, which is the position where the image would be in focus for this specimen region.

In a scanning system, the image should be kept in focus as accurately as possible while the stage moves the specimen continuously. Referring to FIG. 3, this is accomplished by using the distance offset between the current focal position 328, and the computed peak focal position 312, to control the stage-to-objective distance.

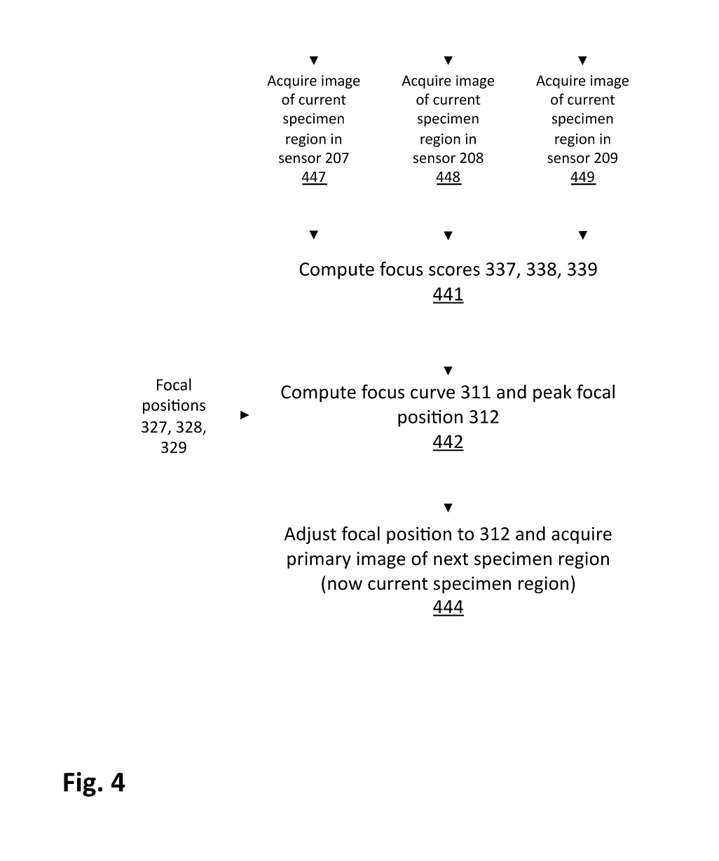

FIG. 4 is a flowchart presenting an embodiment of the method of the present disclosure outlined above. All three sensors 207, 208, and 209 acquire images of the same specimen region (Steps 447, 448, and 449). The images acquired by the three sensors are utilized by an algorithm implemented in the autofocus computer to compute focus scores 337, 338, and 339 (Step 441). Another algorithm implemented in the autofocus computer utilizes the three focus scores and the three focal positions 327, 328, and 329, to compute a focus curve and locates the peak of the focus curve and thus the peak focal position 312 (Step 442). The stage controller is instructed to move the focal position to the computed peak focal position 312. The system then acquires the primary image at the next specimen region at the peak focal position (Step 444).

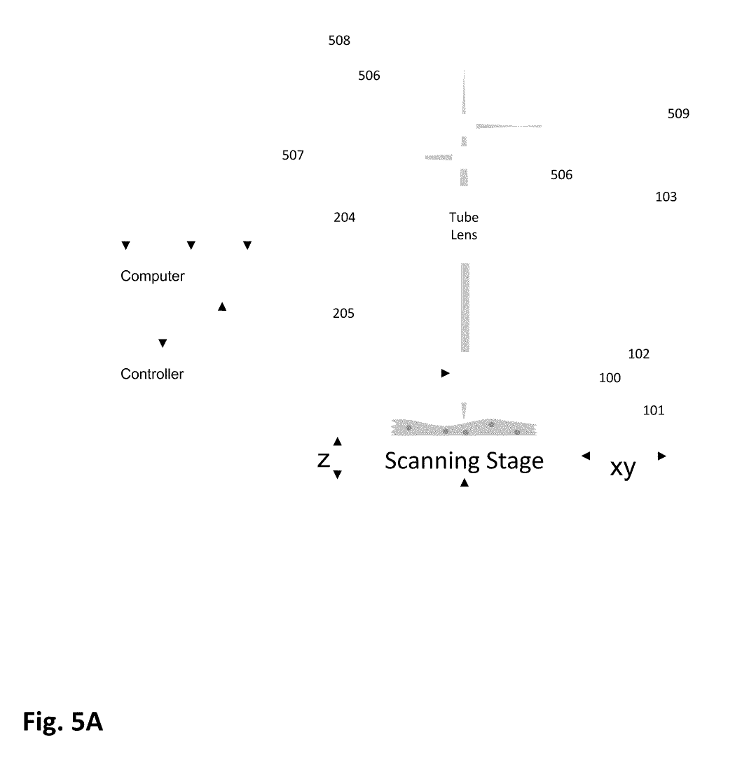

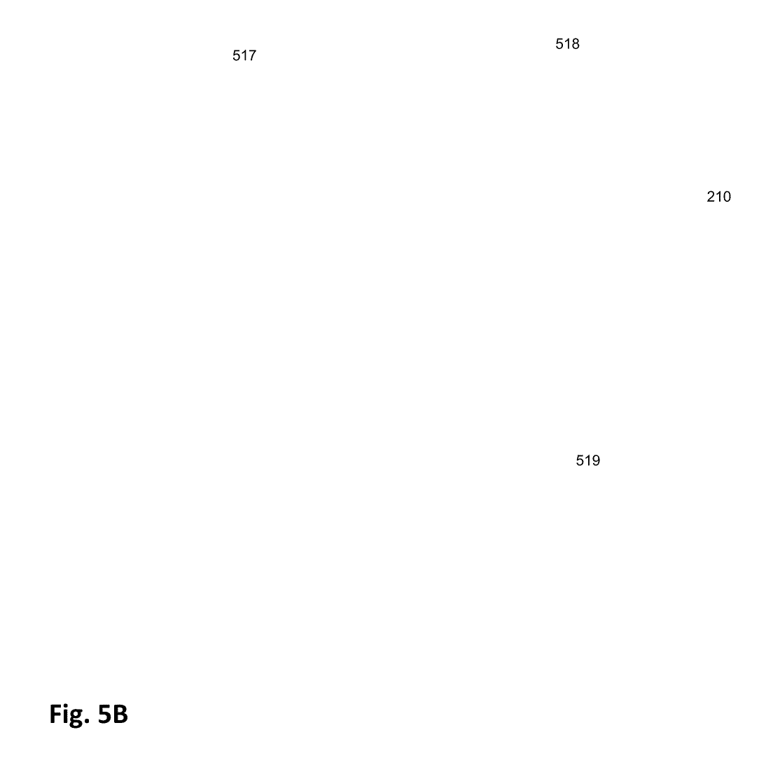

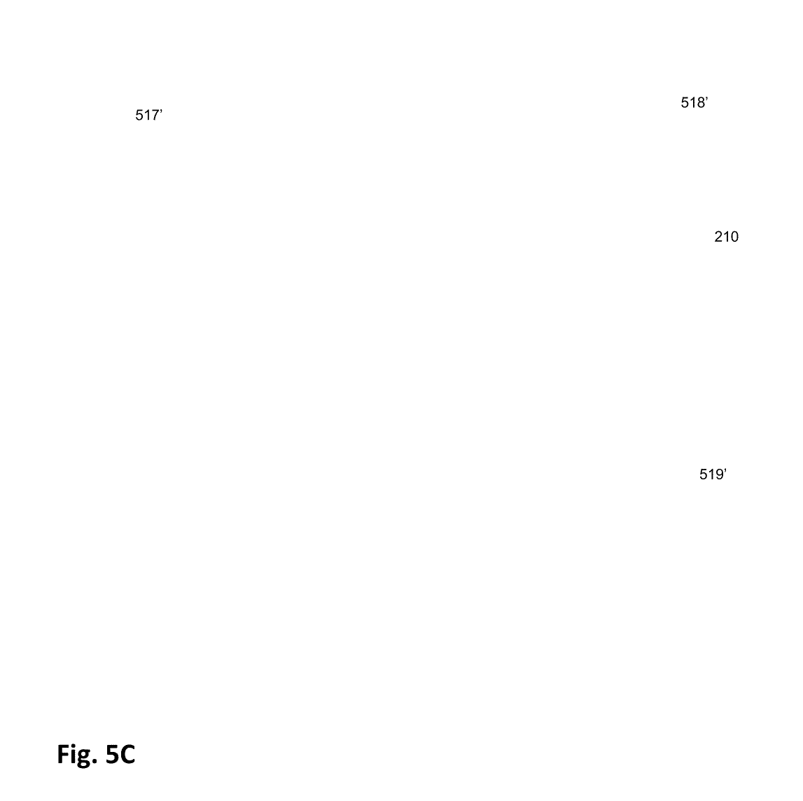

In some embodiments, beamsplitters 506 may be used to generate alternative optical paths for the autofocus image sensors as shown in FIG. 5A. In some embodiments, the beamsplitters may be designed to reflect a small portion of the light energy, leaving the major portion of the light for the primary image sensor. The use of beamsplitters enables the fields of view of the image sensors to substantially overlap. An embodiment with overlapping fields of view 517, 518, and 519 are depicted in FIG. 5B. For clarity, the fields of view are shown as slightly displaced from each other in these figures, but in reality, the fields of view can be substantially identical. The overlapping fields of view in FIG. 5B are those of linescan or TDI linescan image sensors. FIG. 5C shows the overlapping fields of view 517′, 518′, and 519′ of an embodiment utilizing 2D area image sensors, again shown with exaggerated displacement for clarity. In the embodiments with substantially identical fields of view, all the image sensors are imaging the same specimen region at different focal positions simultaneously.

In some embodiments, wavelength-specific beamsplitters can be employed to determine the portion of the light spectrum that is used for the autofocus image sensors. In various embodiments, the portion of the spectrum used for the autofocus image sensors may do one of substantially overlap, partially overlap, and be substantially separated from the portion of the spectrum used for the primary image sensor. In other embodiments, spectral separation between the autofocus image sensors and the primary image sensor is achieved by using spectral filters in one of the optical paths.

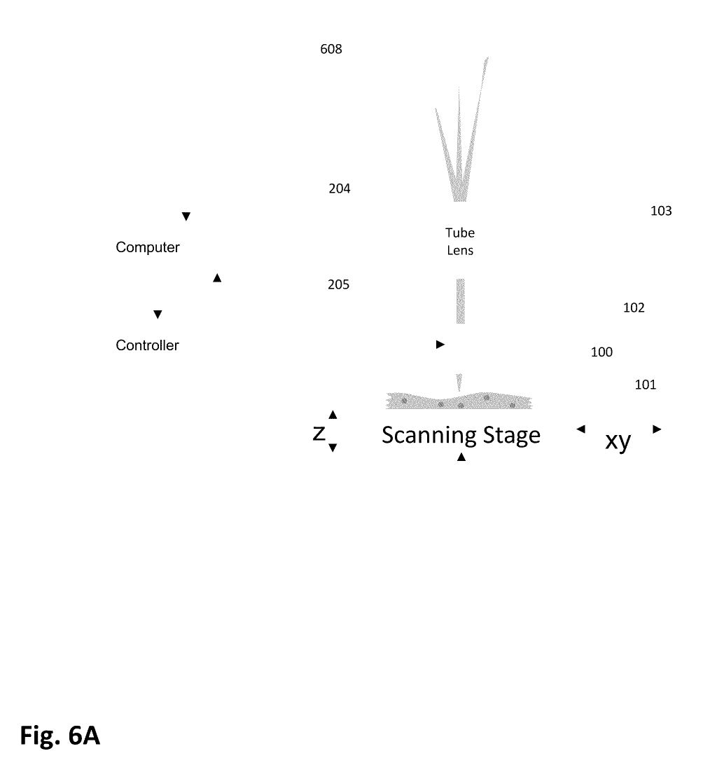

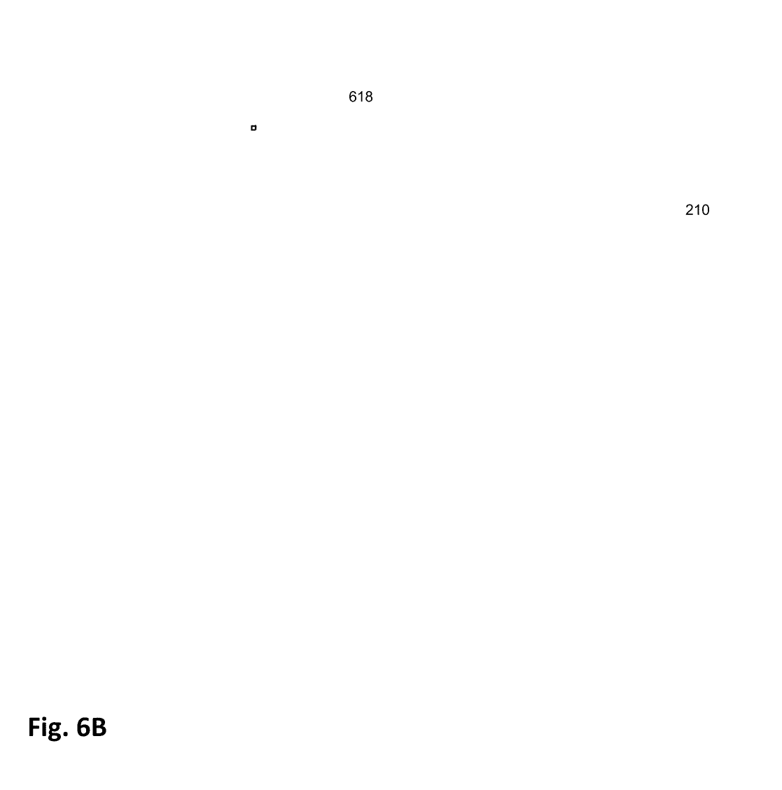

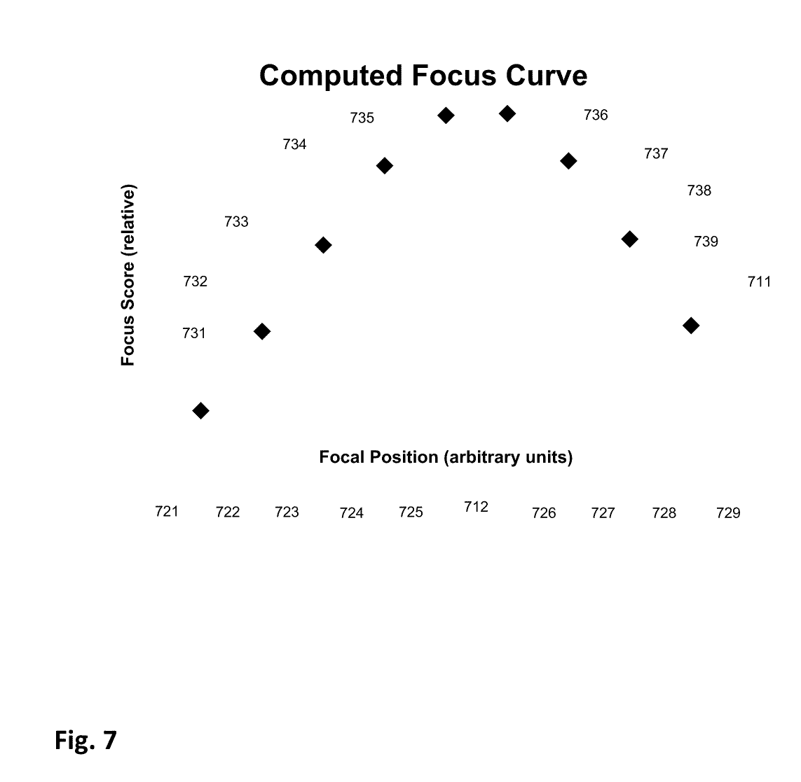

Another embodiment is shown in FIG. 6A, where there is one image sensor 608, which is tilted with respect to the optical axis. The specimen is imaged onto the image sensor at multiple focal positions simultaneously. The image is segmented into narrow strips perpendicular to the tilt direction, so that each strip contains an image within a narrow range of focal positions. This is shown schematically in FIG. 6B. Each image segment will have an image of the same specimen region at successive time slices. This will enable the computation of a focus score for each image segment, corresponding to its focal position. From this plurality of focus scores, focus curve 711 is computed as shown in FIG. 7. From this computed focus curve the peak focal position 712 and a focus correction amount can be computed as described above. In this embodiment, a large number of points on the focus curve contributes to a robust focus determination. The designation of which image segment is used as the primary image can be made dynamically: the image segment which is closest to peak focus can be used as the primary image for a particular specimen region.

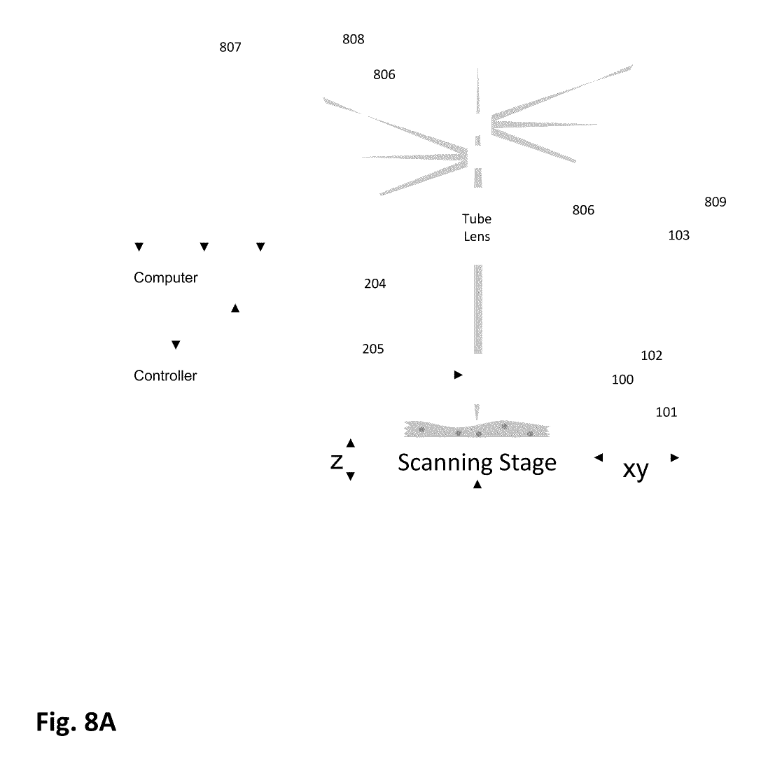

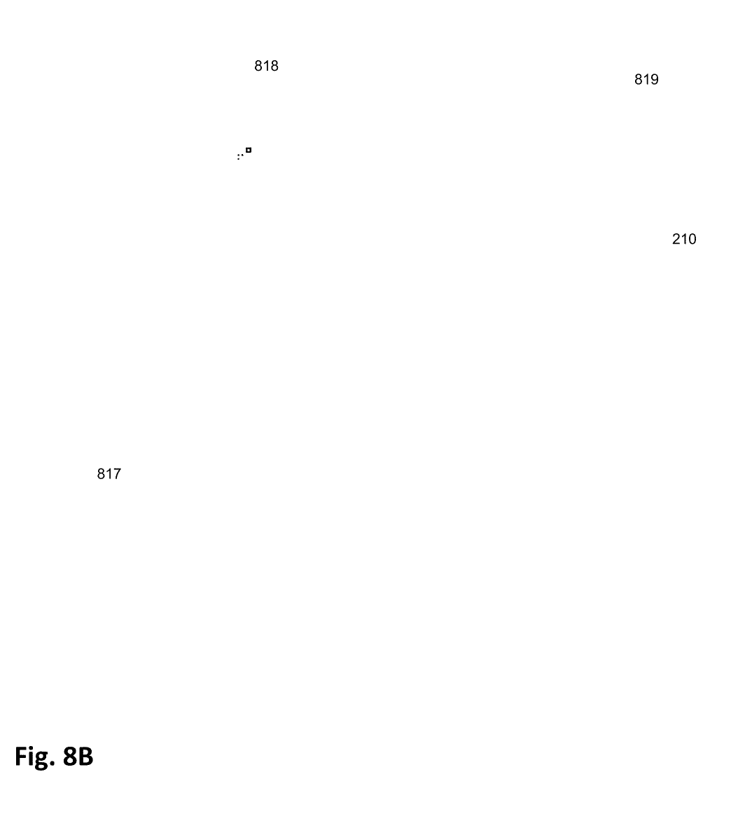

Another embodiment is shown in FIG. 8A. There is one primary image sensor 808 at a single focal position. There are two autofocus image sensors, 807 and 809, which are placed in auxiliary optical paths created by beamsplitters 806. Each autofocus image sensor is tilted with respect to the optical axis, thereby sampling many focal positions simultaneously. In one embodiment, the autofocus image sensors are arranged so that each focal position is sampled twice, once on image sensor 807, and once on image sensor 809. In an alternative embodiment, the autofocus image sensors are arranged so that one image sensor samples multiple focal positions short of the focal position of the primary image sensor, and the other image sensor samples multiple focal positions long of the focal position of the primary image sensor.

The present disclosure is broad enough to cover different embodiments. In FIG. 2B, the fields of view are shown as rectangles with large aspect ratio. This is typical of linescan and TDI linescan image sensors. In FIG. 2C, the fields of view are shown as rectangles with near unity aspect ratio, which is typical of 2D area sensors. Various embodiments utilize different numbers of image sensors. Other embodiments utilize grayscale (also called black & white) image sensors. Still other embodiments utilize color image sensors. Yet other embodiments utilize combinations of types of sensors. One embodiment utilizes a TDI linescan image sensor for the primary image sensor, and 2D area image sensors for the autofocus image sensors. Another embodiment utilizes a color image sensor for the primary image sensor and grayscale image sensors for the autofocus image sensors. Furthermore, the designation of which sensor is primary and which is autofocus, is arbitrary. Their roles can be swapped and a particular sensor can serve as both autofocus image sensor and primary image sensor.

Many microscopes do not have a telecentric image plane. This implies that the magnification will be slightly different for each of the image sensors placed at different focal positions. Some embodiments accommodate this baseline difference between the image sensors by compensating for it in the calculation of the focus score for each image sensor. Other embodiments accommodate the different magnifications of the image sensors through focus calibration.

The embodiments of the disclosure in which an exclusive property or privilege is claimed are defined as follows:

1. An imaging device comprising:
an objective lens establishing an optical axis;
one or more image sensors placed at a plurality of substantially different axial focal positions;
a stage configured to support a specimen to be imaged and capable of moving in a lateral plane substantially orthogonal to the optical axis;
at least one computing device executing computer-readable instructions stored in its memory and configured to acquire images from each of the image sensors; and
a controller receiving input from the computing device and configured to adjust the axial stage-to-objective distance.

2. A system and method for maintaining focus in an imaging device;
the imaging device having an objective lens with an optical axis, a stage for supporting a specimen, and a controller for controlling the stage-to-objective distance;
the system comprising:
one or more image sensors placed at a plurality of substantially different axial focal positions, and
at least one computing device executing computer-readable instructions stored in its memory and configured to acquire images from each of the image sensors;
the method comprising:
computing a quantitative image characteristic for each of the images acquired by the computing device,
computing an axial stage-to-objective distance correction based on the computed quantitative image characteristics and the plurality of axial focal positions, and
causing the controller to adjust the axial stage-to-objective distance according to the computed axial stage-to-objective distance correction.

3. A method to compute image characteristics for the purpose of focus determination that does at least one of emphasize and de-emphasize at least one of the image features selected from the group: spectral qualities, color, transmittance, reflectance, polarization retardance, size, shape, and texture.

4. The imaging device of claim 1, wherein at least one of the image sensors is substantially tilted with respect to the optical axis.

5. The system of claim 2, wherein at least one of the image sensors is substantially tilted with respect to the optical axis.

6. The method of claim 2, wherein the computed image characteristic is a computed focus score.

7. The method of claim 6, wherein the computed focus score is calibrated to compensate for a magnification difference between image sensors.

8. The method of claim 2, wherein computing an axial stage-to-objective distance correction comprises fitting a unimodal function and determining the location of the mode of the fitted function.

9. The method of claim 2, wherein the computed image characteristic does at least one of emphasize and de-emphasize at least one of the image features selected from the group: spectral qualities, color, transmittance, reflectance, polarization retardance, size, shape, and texture.

10. The imaging device of claim 1, wherein the image sensors are any combination of types selected from the group: grayscale 2D area image sensor, Bayer color filter 2D area image sensor, 3-chip color image sensor, grayscale linescan image sensor, grayscale TDI linescan image sensor, multi-channel color linescan image sensor, and multi-channel color TDI linescan image sensor.

11. The imaging device of claim 1, wherein the fields of view of the image sensors are separated spatially within the field of view of the objective.

12. The system of claim 2, wherein the fields of view of the image sensors are separated spatially within the field of view of the objective.

13. The imaging device of claim 1, wherein at least one of the image sensors is placed in an alternative optical path generated by a beamsplitter.

14. The system of claim 2, wherein at least one of the image sensors is placed in an alternative optical path generated by a beamsplitter.

15. The imaging device of claim 13, wherein the fields of view of the image sensors substantially overlap within the field of view of the objective.

16. The system of claim 14, wherein the fields of view of the image sensors substantially overlap within the field of view of the objective.

17. The imaging device of claim 1, wherein the image spectra of the image sensors overlap.

18. The imaging device of claim 1, wherein the image spectra of the image sensors are substantially non-overlapping.

19. The system of claim 2, wherein the image spectra of the image sensors overlap.

20. The system of claim 2, wherein the image spectra of the image sensors are substantially non-overlapping.

21. The imaging device of claim 1, wherein the illumination system is one of brightfield transmitted light, brightfield reflected light, darkfield transmitted light, and darkfield reflected light.

22. The imaging device of claim 1, wherein the optical system is one of phase contrast and differential interference contrast.

23. The imaging device of claim 1, wherein the illumination and optical system are for fluorescence microscopy.
